(19) United States
(12) Patent Application Publication
(10) Pub. No.: US 2020/0017680 A1
(43) Pub. Date: Jan. 16, 2020

(54) BIODEGRADABLE POLYMER

(71) Applicant: Nano and Advanced Materials Institute Limited, Hong Kong (HK)

(72) Inventors: Michael Kwun Fung LO, Hong Kong (HK); Chris You WU, Hong Kong (HK); Sheung Yi LI, Hong Kong (HK); Connie Sau Kuen KWOK, Hong Kong (HK)

(21) Appl. No.: 16/032,052

(22) Filed: Jul. 10, 2018

(51) Int. Cl. C08L 67/04; C08G 65/331

(52) U.S. Cl. CPC C08L 67/04; C08L 2201/06; C08G 65/331

(57) ABSTRACT

The present invention provides a biodegradable polymer composition having an elongation-at-break of at least 200 percent comprising a polylactic acid-based polymer and a mechanical performance modifier, wherein addition of the mechanical performance modifier to the biodegradable polymer increases the elongation-at-break to at least 200 percent while retaining at least 75 percent of the tensile strength of unmodified polylactic acid polymer and wherein the melting temperature of the biodegradable polymer is within 5 degrees Celsius of the melting temperature of unmodified polylactic acid polymer. In one embodiment, the mechanical performance modifier is poly(ethylene glycol) sorbitol hexaoleate. In another embodiment, the mechanical performance modifier is polycaprolactone.

### FIELD OF INVENTION

The present invention provides a biodegradable polymer. More specifically, the present polymer has an elongation-at-break of at least 200 percent.

### BACKGROUND

Biodegradable polymers are considered as a promising alternative to the accumulation of plastic materials. Promising variants such as polylactic acid, polyhydroxyalkanoate, and thermoplastic starch are heavily investigated for their mechanical strength, elongation and biodegradability. Due to the semicrystalline nature of these materials, they would generally have high tensile strength but short elongation-at-break, typically a few percent before break. The high tensile strength is beneficial to hold the shape of the injection molded or thermoformed parts, e.g. feeding utensils, disposable drinking cups, etc. However, the brittle nature of the said material significantly reduces the amount of deformation undertaken to the parts before total failure. This aspect significantly limits the applicability of the said material to mostly one-time use applications.

To partially address this issue, polylactic acid has been co-blended with polyethylene and other thermoplastics to improve the elongation-at-break performance. However, these conventional thermoplastic blends are not considered fully biodegradable.

### SUMMARY OF INVENTION

Accordingly, a first aspect of the present invention relates to a biodegradable polymer composition for forming a biodegradable polymer having an improved elongation-at-break without impairing the tensile strength thereof while the biodegradability of the polymer is maintained. The present biodegradable polymer composition comprises a polylactic acid-based polymer; poly(ethylene glycol) sorbitol hexaoleate as a mechanical performance modifier, wherein addition of the mechanical performance modifier to the biodegradable polymer increases the elongation-at-break to at least 200 percent while retaining at least 75 percent of the tensile strength of unmodified polylactic acid polymer and wherein the melting temperature of the biodegradable polymer is within 5 degrees Celsius of the melting temperature of unmodified polylactic acid polymer.

A second aspect of the present invention relates to an alternative composition for forming a biodegradable polymer having the same or similar mechanical properties as in the first aspect of the present invention comprising polylactic acid including polycaprolactone as a mechanical performance modifier, wherein addition of the mechanical performance modifier to the biodegradable polymer increases the elongation-at-break to at least 200 percent while retaining at least 75 percent of the tensile strength of unmodified polylactic acid polymer and wherein the melting temperature of the biodegradable polymer is within 5 degrees Celsius of the melting temperature of unmodified polylactic acid polymer.

In one embodiment, the mechanical performance modifier is present in an amount of approximately 0.2 to approximately 5 wt %.

This Summary is intended to provide an overview of the present invention and is not intended to provide an exclusive or exhaustive explanation.

### DETAILED DESCRIPTION OF INVENTION

The present invention is not to be limited in scope by any of the following descriptions. The following examples or embodiments are presented for exemplification only.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### Definitions

The singular forms “a,”, “an” and “the” can include plural referents unless the context clearly dictates otherwise.

The term “about” can allow for a degree of variability in a value or range, for example, within 10%, or within 5% of a stated value or of a stated limit of a range.

The term “independently selected from” refers to referenced groups being the same, different, or a mixture thereof, unless the context clearly indicates otherwise. Thus, under this definition, the phrase “X1, X2, and X3 are independently selected from noble gases” would include the scenario where, for example, X1, X2, and X3 are all the same, where X1, X2, and X3 are all different, where X1 and X2 are the same but X3 is different, and other analogous permutations.

The term “phr” refers to the compound ingredients given as parts per 100 unit mass of the rubber polymer, which is also referred to as the base resin.

### DESCRIPTION

The following examples will illustrate the present invention in more detail.

### EXAMPLES

The embodiments of the present invention can be better understood by referencing the following examples which are offered by way of illustration. The present invention is not limited to the examples given herein.

### Example 1—Selection of Mechanical Performance Modifier

A series of reagents and modifying compounds were examined for their mechanical performance improvement ability, such as elongation-at-break and tensile strength after being incorporated into the biodegradable polymer such as polylactic acid (PLA) based polymer. To begin with, NATUREWORKS® 3052D has been selected as the PLA-based polymer due to its injection moulding grade properties that could be readily applicable for industrial processes. Poly(ethylene glycol) sorbitol hexaoleate (PEG-SHO) represented by formula (I) and polycaprolactone (PCL) represented by formula (II) were chosen as the mechanical performance modifier of the PLA-based biodegradable polymer of the present invention:

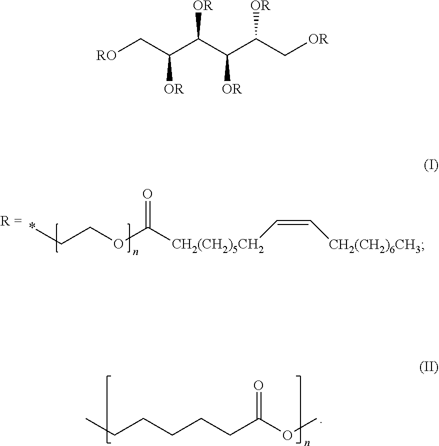

The effects of PEG-SHO and PCL modification on PLA have been investigated by comparing their tensile properties before and after modification. Type V specimens (ISO 527) have been injection moulded from the modified and pristine PLA pellets at a barrel temperature of 215° C., 210° C. and 205° C. using a horizontal Babyplast 6/10P micro-injection molding machine while applying a clamping force of 6 tons. The mechanical tests have been carried out at room temperature on a MTS Exceed® Series 40 Electromechanical Universal Test System. Tensile strength and elongation-at-break were measured.

As shown in Table 1, the modified PLA showed different grade change of tensile strength and elongation-at-break. In particular, PLA modified by PEG-SHO had shown a promising increase of elongation-at-break while the decrease of related tensile strength was less than 20%. These mechanical properties could be further improved by adjusting the content of the modifier. Low molecular weight poly(ethylene) glycol (PEG) such as PEG400, dioctyl adipate (DOA) and corn oil were used as control and comparative modifier as PEG400 and DOA were known to improve elasticity of PLA. Each type of tested polymers was carried out in triplicates.

TABLE 1
Screening of modified PLA formulations

| | Elongation-at-break (%) | | | | | Tensile Strength (N/mm²) | | | | |
|---|---|---|---|---|---|---|---|---|---|---|
| No. | C | PLA-1 | PLA-2 | PLA-3 | PLA-4 | C | PLA-1 | PLA-2 | PLA-3 | PLA-4 |
| 1 | 17.1 | 10.3 | 331 | 11.8 | 92.7 | 46.1 | 44.7 | 35.2 | 29.0 | 24.2 |
| 2 | 18.8 | 10.8 | 349 | 19.0 | 95.1 | 45.2 | 43.8 | 41.6 | 33.4 | 22.5 |
| 3 | 18.3 | 13.4 | 355 | 21.3 | 155 | 45.9 | 39.9 | 38.3 | 32.8 | 28.7 |
| Aver | 18.1 | 11.5 | 345 | 17.4 | 114 | 45.7 | 42.8 | 38.4 | 31.7 | 25.1 |

Sample No. Keys: C: PLA 3052D, PLA-1: C/5 phr PEG400, PLA-2: C/5 phr PEG-SHO, PLA-3: C/5 phr DOA, PLA-4: C/5 phr corn oil; Pull rate was 1 mm/min.

From Table 1, sample PLA-2 (PLA with 5 phr PEG-SHO) could demonstrate a more significant improvement in terms of its elongation-at-break than that of sample PLA-1 (PLA with 5 phr PEG400). PLA modified with 5 phr of corn oil (sample PLA-4) had also demonstrated elongation-at-break of about 114% but the corresponding tensile strength was deteriorated by more than 40% relative to the virgin PLA 3052D (sample C).

The impact of modifier concentration (PEG-SHO and PCL) on their mechanical performance was studied. PCL, which is also a biodegradable polymer, could be a promising candidate for adjusting the mechanical performance while maintain the biodegradability. The elongation of modified PLA could reach to greater than 200% without significantly compromising tensile strength at a loading of 2 phr PEG-SHO. At 5 phr of PEG-SHO, the elongation-at-break was in excess of 300% but the tensile strength would reduce by more than 22% (Table 2). PCL at above 2 phr but no significant improvement in the elongation after 4 phr (Table 3). As seen in the Tables, the elongation-at-break is at least 200 percent and in some cases at least 250 percent and in some cases. at least 300 percent.

TABLE 2
The elongation-at-break and tensile strength of PLA with different PEG-
SHO content (at pull rate at 5 mm/min)

| | PEG-SHO content | | | | |
|---|---|---|---|---|---|
| | C | 1 phr | 2 phr | 3 phr | 5 phr |
| Elongation (%) | 17.2 | 16.8 | 276 | 312 | 336 |
| Tensile-at-break (N/mm²) | 52.4 | 46.1 | 47.9 | 45.6 | 41.1 |
| Tensile Difference | — | −12% | −8% | −13% | −22% |

C: PLA 3052D

TABLE 3
The elongation-at-break and tensile strength of PLA with different
PCL content (at pull rate of 10 mm/min)

| | PCL content | | | | |
|---|---|---|---|---|---|
| | C | 1 phr | 2 phr | 3 phr | 4 phr |
| Elongation (%) | 16.6 | 14.3 | 215 | 277 | 273 |
| Tensile-at-break (N/mm²) | 50 | 55.0 | 41.5 | 49.0 | 48.2 |
| Tensile difference | — | +10% | −17% | −2% | −4% |

C: PLA 3052D

To test the repeatability of the modification, PLA 3052D with different production lots were employed. As shown in Table 4, PLA/2 phr PEG-SHO and PLA/3 phr PCL demonstrated stable improvement on elongation, thus these samples were prepared for biodegradation study.

TABLE 4
The elongation-at-break and tensile strength of PLA 3052D with 2
phr of PEG-SHO or 3 phr of PCL content (pull rate of 5 mm/min)

| | Elongation-at-break (%) | | | Tensile Strength (N/mm²) | | |
|---|---|---|---|---|---|---|
| | | C/2 phr | C/3 phr | | C/2 phr | C/3 phr |
| | C | PEG-SHO | PCL | C | PEG-SHO | PCL |
| #1 | 11.2 | 261 | 257 | 64.0 | 63.3 | 57.3 |
| #2 | 11.9 | 254 | 264 | 66.8 | 62.3 | 56.9 |
| #3 | 10.7 | 251 | 257 | 64.7 | 62.1 | 58.2 |
| Average | 11.3 | 255 | 259 | 65.2 | 62.5 | 57.5 |
| Difference | — | +2156% | +2192% | — | −4.1% | −11.8% |

Thermal Analysis of the Modified PLA Formulations

Thermal analysis via differential scanning calorimetry (DSC) of three PLA samples was performed on TA Q1000 under nitrogen at a scanning speed of 10° C./min. The glass transition temperature and melting temperature of PLA at the second heating curve were summarized in Table 5. The first cycle was conducted to remove the thermal history. From the DSC curve, the glass transition temperature of PLA/2 phr PEG-SHO and PLA/3 phr PCL were slightly lower than control, which suggest that either PEG-SHO or PCL could act as mechanical performance modifier for PLA. The second heating curve of PLA/3 phr PCL may overlap with the melting peak of PCL (˜55.4° C.), showing a two-stage shoulder. Still, the melting point of the three PLA samples was quite similar, indicating the addition of PCL and PEG-SHO would not significantly alter the crystallization of PLA. As seen in Table 5, the melting temperature of the modified compositions is within 5 degrees of the virgin PLA.

TABLE 5
Thermal transitions of virgin PLA, PLA/3 phr PEGSHO and
PLA/2 phr PCL

| | T_{g} | Tₘ |
|---|---|---|
| PLA, virgin | 59.9 | 145.6 |
| PLA/3 phr PEGSHO | 57.3 | 143.1 |
| PLA/2 phr PCL | 60.9 | 145.9 |

Migration Behavior of the Modified Polylactic Acid Formulations

The usability of the modified PLA formulation would need to meet regulatory compliance, which were typically addressed by conducting migration tests to ensure that no significant leachate could be detected upon exposing to simulated foodstuffs. The food simulants were representative of common foodstuffs, containing both water and fatty components. The testing temperatures were relevant to long-term general storage conditions to reflect on longer term stability of the formulations in the presence of foodstuffs. The testing results indicated that there was very little material migrated from the modified polylactic acid formulations, which were deemed suitable for food contact applications per specific FDA and EU usage guidelines (Table 6). In the specific migration for heavy metals, none of the metals were reported up to their specific reporting limit. This latter observation has been expected since none of the formulations in the present invention contains metal.

TABLE 6
Migration testing of leachates from the modified polylactic
acid formulations per FDA and EU regulatory standards

| | | | |
|---|---|---|---|
| Reporting | Permissible | PLA/2 phr | PLA/3 |
| Limit | Limit | PEG-SHO | phr PCL |
| (mg/inch²) | (mg/inch²) | (mg/inch²) | (mg/inch²) |

FDA, 21 CFR 175.300

| Distilled water | 0.1 | 0.5 | Not detected | Not detected |
|---|---|---|---|---|
| 120° F., 24 hr | | | | |
| 8% alcohol | 0.1 | 0.5 | 0.2 mg/inch² | Not detected |
| 120 F., 24 hr | | | | |
| n-Heptane | 0.1 | 0.5 | Not detected | Not detected |
| 70° F., 30 mins | | | | |
| | Reporting | Permissible | PLA/2 phr | PLA/3 |
| | Limit | Limit | PEG-SHO | phr PCL |
| | (mg/dm²) | (mg/dm²) | (mg/dm²) | (mg/dm²) |

EU, EU 10/2 011 at OM2

| | | | | |
|---|---|---|---|---|
| 3% Acetic Acid | 3 | 10 | Not Detected | Not detected |
| 40° C., 10 days | | | | |
| 10% Ethanol | 3 | 10 | Not Detected | Not detected |
| 40° C., 10 days | | | | |
| Rectified | 3 | 10 | Not Detected | Not detected |
| Olive Oil | | | | |
| 40° C., 10 days | | | | |

Biodegradability

The modified polylactic acid polymer formulations of the present invention were subjected to standardized biodegradation testing to evaluate the rate of biodegradation. There are numerous standards for assessing the biodegradability of polymer systems. Most standardized tests either observe the consumption of oxygen or the evaluation of carbon dioxide from degrading of the biodegradable polymers in controlled compositing conditions. For this testing, we have selected the ISO 14855-1 as our assessment method, which relies on measuring the evolution of carbon dioxide relative to the amount of starting polymer. The test calls for an industrial composting condition in a controlled environment. Resins of virgin PLA, PLA/2 phr PEG-SHO and PLA/3 phr PCL have been subjected to the said biodegradability test. TLC grade cellulose was used as the internal control of the biodegradation test, which typically biodegrade more than 70% of its weight within 45 days. Polyethylene was used as the negative control where little to no biodegradation is expected within the testing period. A blank was used to measure the evolution of carbon dioxide with no plastic resins added from the compost, which has been aged for more than three months. The amount of carbon dioxide content in the sealed compost has been measured by titration. The tests are typically stopped on 45 days and passing of 70%; if the percent of subject material biodegraded have been lower than 70% after 45 days, the test could be extended to observe its biodegradability over the next four months. In all cases, the remaining polylactic acid materials were loose, fragile and cannot be distinguished from the compost mixture by naked eye.

Test results in Table 7 reflected that the virgin PLA and PLA/3 phr PCL could be biodegraded to about 94.2% and 88.0%, respectively after 45 days. Surprisingly, PLA/2 phr PEG-SHO could only be partially biodegraded to 40.4% after 45 days and 66.1% after 180 days. By modifying virgin PLA with PEG-SHO, it is demonstrated that the control of biodegradation of PLA in composting condition while still enabling its eventual biodegradation without blending amounts greater than 10 w/w % of thermoplastics or additives. Thus, the biodegradation rate of PLA modified with PEG-SHO is reduced by at least 50 percent. However, the biodegradation rate of PLA modified with PCL is reduced by less than approximately 10 percent.

TABLE 7
The extent of biodegradation in modified polylactic acid formulations and
reference materials per ISO 14855-1

| | Percent biodegraded | Percent biodegraded after |
|---|---|---|
| Formulation | after 45 days | 180 days |
| PLA, virgin | 94.2% | — |
| PLA/3 phr PCL | 88.0% | — |
| PLA/2 phr PEG-SHO | 40.4% | 66.1% |
| Positive reference | 71.0% | 85.7% |
| TLC-grade cellulose | | |
| Negative reference | 0.1% | 2.6% |
| polyethylene | | |

Bacterial Adhesion Study on Virgin and Modified Polylactic Acid

To further understand the biodegradation behavior of PLA/2 phr PEG-SHO, a bacterial adhesion study was performed on plastic surfaces of the same in comparison to the plastic surface of virgin PLA. For plastics to be biodegraded, microorganisms would need to first associate with surfaces of the same. The biodegradation rate is expected to decline when bacterial association to the plastics is poor.

To determine the general bacterial association to plastics, a specific testing procedure has been adapted for both Escherichia coli (E. coli) and Staphylococcus aureus (S. aureus).

Preparation of Test Inoculum of E. coli (ATCC® 8739™) or S. aureus (ATCC 6538P™)

Test inoculum of E. coli or S. aureus was prepared in reference to the Japanese industrial standard (JIS Z 2801:2000). The procedures of the test can include the following steps:
1) Pick a single colony of E. coli or S. aureus from the agar plate and transfer it to 3 mL Nutrient Broth for culturing an overnight (typically 18 hours);
2) Harvest the E. coli (OD at 600 nm to 0.572) or S. aureus (OD at 600 nm to 1.50-1.60) by centrifuge at 8,000 rpm for 1 mins; record the dilution ratio to obtain the OD readings
3) Remove the supernatant and wash the E. coli three times by 1/500 NB solution (1/500 NB refers to the 500×diluted Nutrient Broth with pH adjusted to 6.8-7.2);
4) Resuspend the obtained E. coli in 1/500 NB solution to prepare a bacterial solution as the test inoculum.

Sample Incubation and Swab Test

The inoculation of flat disc samples with test inoculum (E. coli) was performed at 37° C. for 24 hours. A swab test was used to examine the E. coli attached on the sample surface. The experimental procedure is as follows:
a. Transfer 2 mL of as-prepared E. coli or S. aureus solution onto the sample surface and incubate at 37° C. for 24 hours.
b. Carefully remove the E. coli or S. aureus solution and briefly rinse the sample surface in saline twice, 5 mL each time.
c. Use a sterile cotton tipped applicator (3M Quick Swab) to swab the surface of the sample surface, shake the 1 mL solution inside the Quick Swab with the cotton applicator for 10 seconds and then plate the solution using an automated spiral plater, e.g. Eddy Jet 2.
d. After overnight incubation, colonies formed on the agar plates are counted.

As shown in Table 8, we also observed an extent of adsorption of E. coli & S. aureus colonies on film samples from pristine PLA (NatureWorks 3052D), whereas the samples from the PLA/2 phr PEG-SHO or PLA/5 phr PEG-SHO displayed nearly 100% reduction of colony counts in the swab test described above. This observation suggested the surface bacterial adhesion of the biodegradable material were affected by the presence of PEG-SHO on the surface and in the bulk. This change of bacterial adhesion altered the biodegradation rate of the material. By adjusting the loading of the PLA modifiers, the rate of biodegradation of the PLA with high elongation can be controlled. As seen in the table, the reduction in colony formation is at least 90 percent for PLA modified with PEG-SHO for both types of bacteria.

TABLE 8
Colonies forming unit (cfu) on virgin PLA and modified PLA
formulations after collecting bacteria adhered on PLA substrates

| | E. coli | Reduction | S. aureus | Reduction |
|---|---|---|---|---|
| | (cfu/mL) | (%) | (cfu/mL) | (%) |
| Virgin PLA | 1.53 × 10⁵ | — | 1.30 × 10⁵ | — |
| PLA/2 phr PEG-SHO | 1.58 × 10³ | 99.0% | 1.01 × 10⁴ | <93% |
| PLA/5 phr PEG-SHO | <1 × 10¹ | >99.9% | <1 × 10¹ | >99.9% |

To estimate the effect of modifier selection to the adhesion of bacteria on polylactic acid, the bacterial counts on PLA/2 phr PEG-SHO and PLA/3 phr PCL have been noted (Table 9). Data from a separate set of experiment strongly confirms that PLA/2 phr PEG-SHO had a strong anti-fouling effect against both E. coli and S. aureus. This observation generally agrees with the reduction in the rate of biodegradation of PLA/2 phr PEG-SHO. The second modified formulation, PLA/3 phr PCL, has a slight reduction in the bacterial adhesion, but it was not sufficient to cause a change in the rate of its biodegradation. As seen in Table 9, the reduction of bacterial colony formation for E. coli is at least 60 percent for PLA modified by PCL.

TABLE 9
Colonies forming unit (cfu) on virgin PLA, PLA/2 phr PEG-SHO
and PLA/3 phr PCL formulations after collecting bacteria
adhered on PLA substrates

| | E. coli | Reduction | S. aureus | Reduction |
|---|---|---|---|---|
| | (cfu/mL) | (%) | (cfu/mL) | (%) |
| Virgin PLA | 2.50 × 10⁴ | — | 9.02 × 10⁴ | — |
| PLA/2 phr PEG-SHO | 0 | 99+% | 0 | 99+% |
| PLA/3 phr PCL | 8.99 × 10³ | 64% | 8.59 × 10⁴ | 5% |

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### INDUSTRIAL APPLICABILITY

The biodegradable polymer of the present invention is useful in making article requiring certain safety when being applied with foodstuff or in medical implant due to its mechanical properties, biocompatibility and biodegradability. Since the selected biodegradable polymer of the present invention, PLA, is easily processed in industrial scale and only a small amount of the selected mechanical performance modifier is used, the cost of manufacturing the modified PLA-based biodegradable polymer is relatively lower than conventional biodegradable polymer with similar mechanical properties.

1. A biodegradable polymer composition having an elongation-at-break of at least 200 percent comprising:
a polylactic acid-based polymer;
poly(ethylene glycol) sorbitol hexaoleate as a mechanical performance modifier;
wherein addition of the mechanical performance modifier to the biodegradable polymer increases the elongation-at-break to at least 200 percent while retaining at least 75 percent of the tensile strength of unmodified polylactic acid polymer and wherein the melting temperature of the biodegradable polymer is within 5 degrees Celsius of the melting temperature of unmodified polylactic acid polymer.

2. The biodegradable polymer composition of claim 1, wherein the mechanical performance modifier is present in an amount of approximately 0.2 to approximately 5 wt %.

3. The biodegradable polymer composition of claim 1, wherein the polymer composition exhibits at least approximately 50 percent reduction in the rate of biodegradation after the first 45 days in composting condition.

4. The biodegradable polymer composition of claim 1, wherein the polymer composition exhibits a greater than 90 percent reduction in the formation of surface bacteria colonies.

5. The biodegradable polymer composition of claim 1, wherein the elongation-at-break is greater than 250 percent.

6. A biodegradable polymer composition having an elongation-at-break of at least 200 percent comprising:
polylactic acid including polycaprolactone as a mechanical performance modifier;
wherein addition of the mechanical performance modifier to the biodegradable polymer increases the elongation-at-break to at least 200 percent while retaining at least 75 percent of the tensile strength of unmodified polylactic acid polymer and wherein the melting temperature of the biodegradable polymer is within 5 degrees Celsius of the melting temperature of unmodified polylactic acid polymer.

7. The biodegradable polymer composition of claim 6, wherein the mechanical performance modifier is present in an amount of approximately 0.2 to approximately 5 wt %.

8. The biodegradable polymer composition of claim 6, wherein the polymer composition exhibits less than approximately 10 percent reduction in the rate of biodegradation.

9. The biodegradable polymer composition of claim 6, wherein the polymer composition exhibits a greater than 60 percent reduction in the formation of surface E. coli bacteria colonies.

10. The biodegradable polymer composition of claim 6, wherein the elongation-at-break is greater than 250 percent.
